(19) United States
(12) Patent Application Publication
(10) Pub. No.: US 2007/0011441 A1
(43) Pub. Date: Jan. 11, 2007

(54) Method and system for data-driven runtime alignment operation

(75) Inventors: Alexandre E. Eichenberger, Chappaqua, NY (US); Michael Gschwind, Chappaqua, NY (US); Valentina Salapura, Chappaqua, NY (US); Peng Wu, Fairport, NY (US)

Correspondence Address: MICHAEL J. BUCHENHORNER, 8540 S.W. 83 STREET, MIAMI, FL, 33143, US

(73) Assignee: International business Machines Corporation

(21) Appl. No.: 11/176,988

(22) Filed: Jul. 8, 2005

(51) Int. Cl. G06F 9/44

(52) U.S. Cl. 712/221

(57) ABSTRACT

A method for processing instructions and data in a processor includes steps of: preparing an input stream of data for processing in a data path in response to a first set of instructions specifying a dynamic parameter; and processing the input stream of data in the same data path in response to a second set of instructions. A common portion of a dataflow is used for preparing the input stream of data for processing in response to a first set of instructions under the control of a dynamic parameter specified by an instruction of the first set of instructions, and for operand data routing based on the instruction specification of a second set of instructions during the processing of the input stream in response to the second set of instructions.

### FIELD OF THE INVENTION

The present invention generally relates to the implementation of microprocessors, and more particularly to an improved processor implementation having a data path for data preparation and data processing.

### BACKGROUND

Contemporary high-performance processors support single instruction multiple data (SIMD) techniques for exploiting instruction-level parallelism in programs; that is, for executing more than one operation at a time. SIMD execution is a computer architecture technique that performs one operation on multiple sets of data. In general, these processors contain multiple functional units, some of which are directed to the execution of scalar data and some of which are grouped for the processing of structured SIMD vector data. SIMD data streams are often used to represent vector data for high performance computing or multimedia data types, such as color information, using, for example, the RGB (red, green, blue) format by encoding the red, green, and blue components in a structured data type using the triple (r,g,b), or coordinate information, by encoding position as the quadruple (x, y, z, w).

A first microprocessor supporting this type of processing was the Intel i860 as described by L Kohn and N Margulis in “Introducing the Intel i860 64-bit microprocessor,” IEEE Micro, Volume 9, Issue 4, August 1989, Pages 15-30. As in many of the early short vector SIMD instruction extensions, the Intel i860 SIMD short parallel vector extension was directed at graphics processing. The Intel i860 targeted hand-tuned assembly code for graphics, with programmer-tuned data layout to avoid access to unaligned data and required assembly code to access the parallel short vector SIMD facility.

Several other short vector SIMD extensions followed this model, notably the HP PA-RISC MAX, Sun SPARC VIS, and Intel x86 MMX extensions. Like the i860 graphics instruction set, these extensions targeted the processing of graphics data. The initial programming model for these extensions was assembly coding, with a later shift towards “intrinsic”-based programming which provides a way to specify assembly instructions in-line with traditional high-level code by masquerading inline assembly instructions as pseudo function calls. The main advantage of this approach is to allow general control structures to be specified in a higher-level language such as C, or C++, and to use the compiler backend for register allocation and (optionally) instruction scheduling of short parallel vector SIMD instructions.

The MAX extensions are described by R. Lee, “Accelerating Multimedia with Enhanced Microprocessors”, IEEE Micro, Volume 15, Issue 2, April 1995, Pages 22-32. The VIS extensions are described by Kohn et al., “The visual instruction set (VIS) in UltraSPARC”, Compcon (1995); “Technologies for the Information Superhighway” Digest of Papers, 5-9 March 1995, Pages 462-469; and Tremblay et al., “VIS Speeds New Media Processing”, IEEE Micro, August 1996, pages 10-20.

The HP PA-RISC MAX extension used the integer register file in lieu of the FP file. No explicit support for accessing unaligned data was present which is consistent with the underlying HP Precision Architecture model. In the HP Precision architecture, processors (e.g., the Series 700 processors) require data to be accessed from locations that are aligned on multiples of the data size. The C and FORTRAN compilers provide options to access data from misaligned addresses using code sequences that load and store data in smaller pieces, but these options increase code size and reduce performance. A library routine is also available under HP-UX (HP's UNIX variant for the Precision Architecture) to handle misaligned accesses transparently. It catches the bus error signal and emulates the load or store operation.

The compilers normally allocate data items on aligned boundaries. Misaligned data usually occurs in FORTRAN programs that use the EQUIVALENCE statement for creative memory management. Pointers to misaligned data can be passed from FORTRAN routines to C routines in mixed source programs.

Programmers for the HP MAX extensions are expected to handle alignment by manually performing data layout to the required alignment. This is consistent with the assembly or intrinsic programming style which restricts use of the media extensions to expert coders for compute-intensive inner loops, or highly tuned application libraries. This approach allowed the HP-PA to implement software MPEG decoding by parallelizing narrow data on a wider data path (“subword parallelism”) ahead of other processor vendors, but also limited general usability of the media architecture extensions.

The SPARC VIS instruction set extension was the first media ISA (instruction set architecture) to support data alignment primitives with the vis_falignaddr and vis_faligndata instructions. Accessing unaligned data streams using these primitives is preferable to supporting unaligned load and store operations, because an unaligned access causes degradation of performance when data must be accessed from two separate cache or other memory subsystem lines, corresponding to a first and a second access. Furthermore, some micro-architectures assume speculatively that all accesses will be aligned and require an additional misprediction penalty for unaligned accesses which can be very substantial. Using a series of aligned accesses and performing dynamic data rearrangement in the high performance CPU as opposed to performing such operations is supported by the SPARC VIS instruction set.

In accordance with the VIS instruction set architecture, as described by Sun Microsystems in “VIS Instruction Set User's Manual”, Part Number: 805-1394-03, May 2001, the instructions vis_falignaddr and vis_faligndata calculate 8-byte aligned address and extract an arbitrary eight bytes from two 8-byte aligned addresses.

The instructions vis_falignaddr( ) and vis_faligndata( ) are usually used together. Instruction vis_falignaddr( ) takes an arbitrarily-aligned pointer addr and a signed integer offset, adds them, places the rightmost three bits of the result in the address offset field of the GSR, and returns the result with the rightmost three bits set to 0. This return value can then be used as an 8-byte aligned address for loading or storing a vis_d64 variable.

The instruction vis_faligndata( ) takes two vis_d64 arguments data_hi and data_lo. It concatenates these two 64-bit values as data_hi, which is the upper half of the concatenated value, and data_lo, which is the lower half of the concatenated value. Bytes in this value are numbered from most-significant to the least-significant with the most-significant byte being zero (0). The return value is a vis_d64 variable representing eight bytes extracted from the concatenated value with the most-significant byte specified by the GSR offset field, where it is assumed that the GSR address offset field has the value five.

Care must be taken not to read past the end of a legal segment of memory. A legal segment can begin and end only on page boundaries; and so, if any byte of a vis_d64 lies within a valid page, the entire vis_d64 must lie within the page. However, when addr is already 8-byte aligned, the GSR address offset bits are set to 0 and no byte of data_lo is used. Therefore, although it is legal to read eight bytes starting at addr, it may not be legal to read 16 bytes, and this code will fail.

The following example shows how these instructions can be used together to read a group of eight bytes from an arbitrarily-aligned address as follows:

void *addr;
vis_d64 *addr_aligned;
vis_d64 data_hi, data_lo, data;
addr_aligned = (vis_d64*) vis_alignaddr(addr, 0);
data_hi = addr_aligned[0];
data_lo = addr_aligned[1];
data = vis_faligndata(data_hi, data_lo);

When data are being accessed in a stream, it is not necessary to perform all the steps shown above for each vis_d64. Instead, the address may be aligned once and only one new vis_d64 read per iteration:

addr_aligned = (vis_d64*) vis_alignaddr(addr, 0);
data_hi = addr_aligned[0];
for (i = 0; i < times; ++i) {
data_lo = addr_aligned[i + 1];
data = vis_faligndata(data_hi, data_lo);
/* Use data here. */
/* Move data “window” to the right. */
data_hi = data_lo;
}

The same considerations concerning “ahead” apply here. In general, it is best not to use vis_alignaddr( ) to generate an address within an inner loop, for example:

{
addr_aligned = vis_alignaddr(addr, offset);
data_hi = addr_aligned[0];
offset += 8;
/* ... */
}

The data cannot be read until the new address has been computed. Instead, compute the aligned address once, and either increment it directly or use array notation. This will ensure that the address arithmetic is performed in the integer units in parallel with the execution of the VIS instructions.

Although the described alignment primitives allow high performance alignment of a data stream, they are limited to a single stream at a time, because a global field in the global graphics status register GSR is used.

Thus, when multiple streams must be aligned, repeated vis_falignaddr instructions must be inserted in the loop body in lieu of the loop header (unless the compiler can prove statically at compile time that multiple streams are misaligned by the same amount).

Alternatively, alignment can also be performed using the byte mask and shuffle instruction primitives, vis_read bmask( ), vis_write bmask( ), and vis_bshuffle( ). But these instructions suffer from the same limitation as there is only one global graphic status register GSR in which to keep the shuffling pattern (read and set by vis_read_bmask( ), vis_write_bmask( ), respectively) and used by the vis_bshuffle( ) instruction.

This limitation is addressed by the PowerPC VMX instruction set extension with the permute instruction (These instruction set extensions are also known by the brand names “Altivec” and “Velocity Engine”) and the lvsl and lvsr permute mask computation instructions.

In the PowerPC VMX extensions, there are provided a number of load/store instructions to transfer data in and out of the vector registers. The load vector indexed (lvx, lvxl) and store vector indexed (stvx, styl) instructions transfer 128-bit quadword quantities between memory and the AltiVec registers. Two source registers specify the effective address of the memory location that's the target of the operation. The first source register is typically an offset value, while the second register holds a base address (a pointer).

The load and store instructions can be combined with the vperm permute and lvsl permute mask computation instructions to create sequence to load unaligned data. This is achieved by a sequence of two lvx instructions, one lvsl and one permute instruction. In this sequence, the lvsl instructions are used to read the two quadwords that contain the vector's data. Following this data read access phase, the lvsl and vperm permute instructions are used the vector permute instruction to extract bytes from each quadword and reconstruct the vector.

In PowerPC VMX, the vector memory operations (such as lvx, lvxl, stvx, stvxl) ignore the least significant address bits to automatically read an aligned quadword surrounding a potentially unaligned address. This is advantageous compared to the Sun SPARC VIS approach, because no falignaddr instruction is needed to align the data address prior to executing memory operations which reduces schedule height.

The lvsl instruction sets up a “control register” which is a general vector register to store the permute control word so that vperm merges the proper bytes in the destination register. Note that because the control word which specifies the instructions for the data realignment step is stored in a general purpose register being advantageously more flexible than the Sun VIS extensions, because multiple vector registers can be used to store multiple realignment control words for multiple streams in several different vector registers simultaneously.

The lvsl instruction (“Load Vector Shift Left”) is provided the address of the misaligned quadword, and it generates a control vector for vperm. Vperm then performs what amounts to a “super shift” left of the concatenated quadwords. A similar instruction, Load Vector Shift Right (lvsr), generates a control vector for “right shifting” the vector data.

We now describe the behavior of these instructions and illustrate the data flow during the data realignment process in PowerPC VMX. The following code fragment shows “intrinsic”-based code for this process:

vector signed char highQuad, lowQuad, control Vect;
unsigned char * vPointer;
// Fetch quadword with most significant bytes of misaligned vector
highQuad = vec_ld(0, (unsigned char *) vPointer);
// Make control vector for permute op
controlVect = vec_lvsl(0, (unsigned char *) vPointer));
// quadword with vector's least significant bytes
lowQuad = vec_ld(16, (unsigned char *) vPointer);
destVect = vec_perm(highQuad, lowQuad, controlVect);

Note that the PowerPC VMX extensions advantageously also specify that in fact, when an AltiVec load/store instruction is presented with a misaligned address, the vector unit ignores the low-order bits in the address and accesses the data instead starting at the data type's natural boundary. A boundary is a memory location whose address is an integral multiple of the data element's size. For example, a quadword boundary consists of memory locations whose addresses are a multiple of sixteen. That is, the four least significant bits of a quadword's boundary address are zeros.

This was done to simplify the sequence of instructions needed. For situations where the load/permute operations are part of a loop that reads streaming data, the overhead of the permute operation can be amortized over more instructions by unrolling the loop.

Thus, while recent advanced SIMD architectures such as PowerPC VMX allow dynamic data re-alignment of multiple streams at high performance, their alignment primitives are expensive because they have been implemented to be general, and to serve a variety of other purposes in addition to data preparation, such as alignment management.

Thus, the SPARC VIS implementation requires a separate shift which can perform general purpose shifts of up to 7 bytes. This is a separate unit as described in D. Greenly et al., “UltraSPARC: the next generation superscalar 64-bit SPARC”, Compcon '95 ‘Technologies for the Information Superhighway’, Digest of Papers, 5-9 March 1995, Pages 442-451.

The permute instructions specified in PowerPC VMX, and other instructions (such as align instructions on Sun SPARC) serve a variety of data formatting and arrangement purposes, and are implemented as a separate unit in microprocessor implementations.

This makes sense for short parallel vector SIMD extensions geared mostly towards graphics acceleration processing, as is the case for the VIS, MMX, MAX, and similar instruction sets, and described by Lee and Huck, “64-bit and Multimedia Extensions in the PA-RISC 2.0 Architecture,” HP Whitepaper, 1996, and by Lee, “Processor for performing subword permutations and combinations” (see U.S. Pat. No. 6,381,690), and by Lee, “Efficient selection and mixing of multiple sub-word items packed into two or more computer words,” (U.S. Pat. No. 5,673,321).

While some media accelerators have also found use in general purpose computing acceleration (notably, the IBM PowerPC VMX and Intel x86 SSE extensions), a shift to focusing on general purpose computing acceleration started with the definition of the IBM CELL architecture, as disclosed by Altman et al., “Symmetric MultiProcessing System With Attached Processing Units Being Able To Access A Shared Memory Without Being Structurally Config.D With An Address Translation Mechanism,” U.S. Pat. No. 6,779,049, and specifically the APU instruction set architecture (also referred to as “SPU architecture”), Gschwind et al, “Processor Implementation Having Unified Scalar and SIMD Datapath,” U.S. Published patent application Ser. No. 09/929,805, and M. Gschwind et al., “Method and Apparatus for Aligning Memory Write Data in a Microprocessor, Ser. No. 09/940,911, all assigned to the assignee of the present application and incorporated by reference.

A further step in the direction of general application acceleration, and specifically for scientific applications, is represented by a double FPU (floating point unit) architecture as described in an exemplary manner by Bachega et al., “A High-Performance SIMD Floating Point Unit for BlueGene/L: Architecture, Compilation, and Algorithm Design”, Proc. of the International Conference on Parallel Architectures and Compilation Techniques, Juan-les-Pins, September 2004, and incorporated by reference. Unlike all previous short parallel SIMD vector architectures, the double FPU architecture contains only operations to compute on double precision floating point operations, and no shift or permute operations. The BlueGene/L system is described in more detail by Bright et al., “Creating the BlueGene/L Supercomputer from Low Power SoC ASICs”, ISSCC 2005, February 2005, and incorporated herein by reference.

In parallel with the emergence of short parallel vector SIMD ISAs for general application acceleration as exemplified by the CELL and BGL system, advances in compilation techniques to generate code have allowed to exploit these systems better. S. Larsen and S. P. Amarasinghe, “Exploiting superword level parallelism with multimedia instruction sets”, SIGPLAN Conference on Programming Language Design and Implementation, pages 145-, 2000 describes optimizations to exploit short parallel vector SIMD instruction sets using compiled code from general purpose high level language programs. A. Bik et al. “Automatic intra-register vectorization for the Intel architecture”, International Journal of Parallel Programming”, Volume 30, Issue 2, Pages: 65-98, April 2002, Plenum Press, New York, N.Y. describes further compilation methods for SIMD architectures to accelerate general purpose program. Bachega et al., op cit., incorporated herein by reference, shows improvements to the algorithm described by Larsen and Amarasinghe.

While there is a certain overhead in dealing with runtime alignment, one can still generate computations with optimized data realignment placement, as shown in “Efficient SIMD Code Generation for Runtime Alignment and Length Conversion,” CGO 2005, March 2005.

An issue in generating efficient data reorganization for runtime alignment is that depending on whether the data is shifted left or right, a different code sequence is needed. While optimized data reorganization works well for stream offsets known at compile time, it does not work for runtime alignment for the following reason. As indicated, the code sequence used for shifting streams left or right are different. The problem with runtime alignment is that the compiler does not generally know the direction of the stream shifts at compile time. Indeed, shifting a stream from arbitrary runtime offsets x to y corresponds to a right-shift when x<=y, and a left-shift when x>=y. Thus the compiler is restricted to apply the Zero-shift policy to runtime alignment since the direction of shifting from x to 0 or from 0 to y can always be determined at compile-time.

This code generation problem occurs because we are focusing on the wrong element of the stream. By focusing on a different element of the stream (mechanically derived from the runtime alignment y), we can use a left stream shift code sequence regardless of the alignments x or y. Instead of focusing on the first element of the stream, we focus here on the element that is both at offset zero after shifting the stream and in the same register as the original first value.

Let us now derive two new streams, which are constructed by pre-pending a few values to the original b[i+1] and c[i+3] streams so that the new streams start at, respectively, b[−1] and c[1]. These new streams are shown in FIG. 10A with the pre-pended values in light grey and the original values in dark grey. Using the same definition of the stream offset as before, the offsets of the new memory streams are 12 and 4, respectively.

Consider now the result of shifting the newly pre-pended memory streams to offset zero. As shown in the above FIGS. 10A and 10B, the shifted new streams yield the same sequence of registers as that produced by shifting the original stream (highlighted with dark grey box with light grey circle), as the first values of the original streams, b[1] and c[3], land at the desired offset 8 in the newly shifted stream. This holds because the initial values of the new streams were selected precisely as the ones that will land at offset zero in the shifted version of the original streams. Since shifting any stream to offset zero is a left stream shift, by definition, we have effectively transformed an arbitrary stream shift into a left-shift.

Traditionally media-oriented short parallel vector SIMD architectures can accomplish this using the permute or shift primitives specified for data alignment, e.g., vis_faligndata on Sun SPARC VIS in conjunction with the vis_falignaddr instruction, or the vperm instruction in conjunction with lvsl and lvsr instructions for IBM PowerPC VMX. These primitives require separate data alignment function blocks, which have a number of undesirable aspects:

They require a separate unit, which includes typically a separate, second data path, requiring additional load on the vector SIMD register file (or a second copy of the vector SIMD register file to be maintained), as well as possibly requiring additional write ports. These alignment units based on general shift functionality and/or permute functionality are overly general, and result in units which require large area and high power consumption, adding additional units leads to wiring congestions and makes wiring a design more complex and burdensome. Thus, it is clear that a system and method are needed to perform data preparation for efficient high performance computation integrated into a datapath with minimal overhead, wherein short parallel vector data is prepared by realigning them within a SIMD data path to support efficient SIMD computation using runtime alignment information.

Furthermore, in light of the ever-increasing need to reduce overall power consumption and heat dissipation in the processor, as well as to control latency of the integrated data preparation and data processing path, it is desirable to provide an efficient method with a minimum number of data and control steps to perform such alignment, and further eliminate all setup from the frequently executed loop bodies. Furthermore, it is desirable to allow simultaneous data preparation and alignment of multiple independent data streams using different data preparation control information. It is further desirable to provide instructions in the instruction set to perform data preparation efficiently within a combined data preparation and data processing path, which allows several of these preparation steps on multiple independent streams with different preparation parameters to be performed during a loop without repeated setup of such preparation.

FIG. 1 is a block diagram describing an industry standard processor with media extensions. This structure is based on based on B. Gibbs et al., “IBM E-Server BladeCenter JS20 PowerPC 970 Programming Environment”, IBM Corporation Red Paper, REDP-3890-00. This represents a typical prior art approach to the problems solved by the present invention.

FIG. 2 shows the configuration of a modern media short parallel vector processing unit in accordance with P. Sandon, “PowerPC™970: First in a new family of 64-bit high performance PowerPC processors”, Microprocessor Forum 2002. This illustrates the use of a permuter in the prior art.

FIG. 3 shows an exemplary four-element vector 302 for a short parallel vector SIMD operation 300, and the effect of performing the short parallel vector SIMD operation. Operands 304 operate on vectors 304 and 308 to produce vector 310.

Therefore there is a need for a system that provides a microprocessor instruction specification to support, a microprocessor implementation to provide, and a compiler code generation method to exploit methods and apparatus to (1) provide low overhead data preparation, and specifically runtime data alignment for a short parallel vector SIMD architecture, (2) allow data preparation, and specifically data alignment operations, to be integrated in a data processing path, (3) provide such capabilities with maximum efficiency and minimal overhead, (4) in terms of instruction latency, design size and area, and power dissipation, and (5) improve overall system performance of compiled code.

### SUMMARY OF THE INVENTION

Briefly, according to an embodiment of the invention, A method for processing instructions and data in a processor includes steps of: preparing an input stream of data for processing in a data path in response to a first set of instructions specifying a dynamic parameter; and processing the input stream of data in the same data path in response to a second set of instructions. A common portion of a dataflow is used for preparing the input stream of data for processing in response to a first set of instructions under the control of a dynamic parameter specified by an instruction of the first set of instructions, and for operand data routing based on the instruction specification of a second set of instructions during the processing of the input stream in response to the second set of instructions. Other embodiments include a programmable information processing machine and a computer program product for performing the method.

### BRIEF DESCRIPTION OF THE DRAWINGS

FIG. 1 is a block diagram describing an industry standard processor with media extensions.

FIG. 2 shows the configuration of a modern media short parallel vector processing unit.

FIG. 3 shows an exemplary four element vector for short parallel vector SIMD operation, and the effect of performing a short parallel vector SIMD operation.

FIG. 4 shows the architecture of a short parallel vector SIMD architecture according to an embodiment of the invention.

FIGS. 5a-b show an exemplary two element vector for short parallel vector SIMD operation.

FIGS. 6A-C show the operation of the Sun SPARC VIS falignaddr and faligndata instructions, and the global GSR graphics state register.

FIG. 7 shows the extraction of misaligned data from two aligned quadwords using a sequence of lvx, lvsl, and vperm instructions.

FIG. 8 shows exemplary compilation phases to support acceleration of general purpose programs with compiler-based SIMD acceleration in accordance with an embodiment of the present invention.

FIG. 9 shows different shift policies for static (compile time) data alignment in accordance with an embodiment of the present invention

FIGS. 10a-b show dynamic (runtime) data alignment in accordance with an embodiment of the present invention

FIG. 11 shows the data preparation elements.

FIG. 12 shows an exemplary instruction (“fxsel”) providing runtime controlled data alignment.

FIG. 13 shows the control logic for an implementation of an exemplary “fxsel” dynamic data alignment instruction of FIG. 12 in a data path of FIG. 11:

FIG. 14 shows a flow of data through the BlueGene/L FP2 unit during the execution of the fxsel instruction to perform dynamic (runtime) vectpor data alignment in accordance with an embodiment of the present invention when no realignment is necessary (i.e., when the data is already correctly aligned in the register)

FIG. 15 shows the flow of data through the BlueGene/L FP2 unit during the execution of the fxsel instruction to perform dynamic (runtime) vector data alignment in accordance with an embodiment of the present invention when realignment is necessary (i.e., when the data is already not correctly aligned in the register)

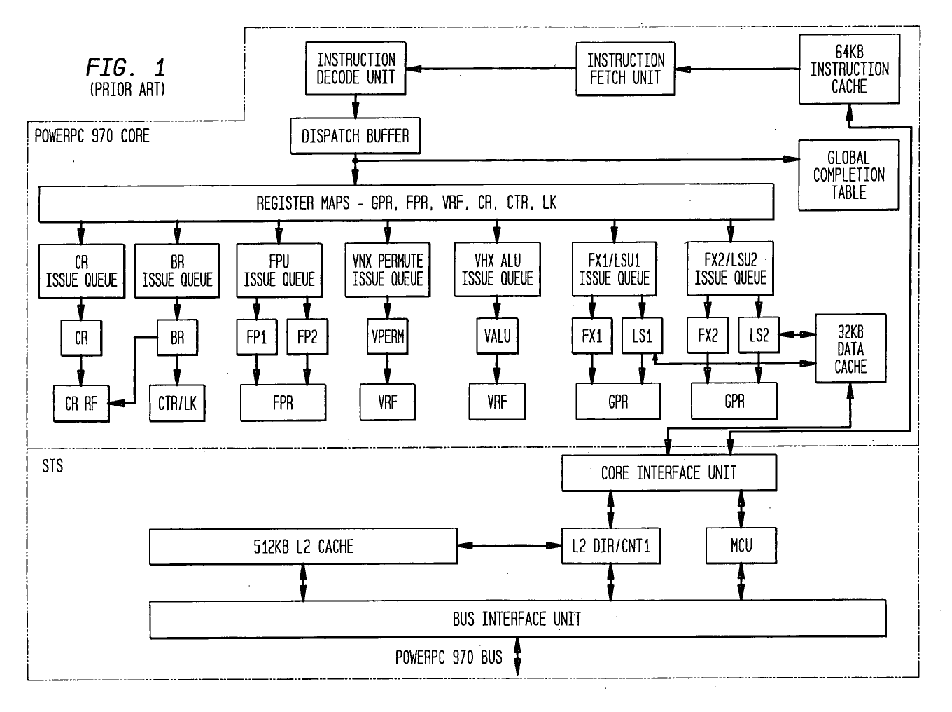

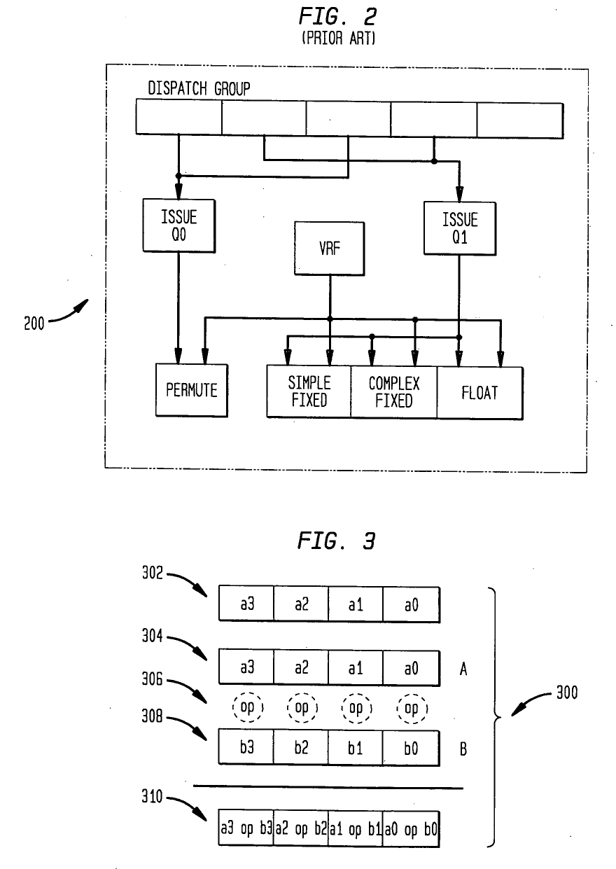

### DETAILED DESCRIPTION

According to an embodiment of the invention, a method for processing instructions and data in a processor comprises steps of: preparing an input stream of data for processing in a data path in response to a first set of instructions specifying a dynamic parameter; and processing the input stream of data in the same data path in response to a second set of instructions. A common portion of the dataflow is used for preparing the input stream of data for processing in response to the first set of instructions under the control of the dynamic parameter specified by an instruction of the first set of instructions, and for operand data routing based on the instruction specification of the second set of instructions during the processing of the input stream in response to the second set of instructions.

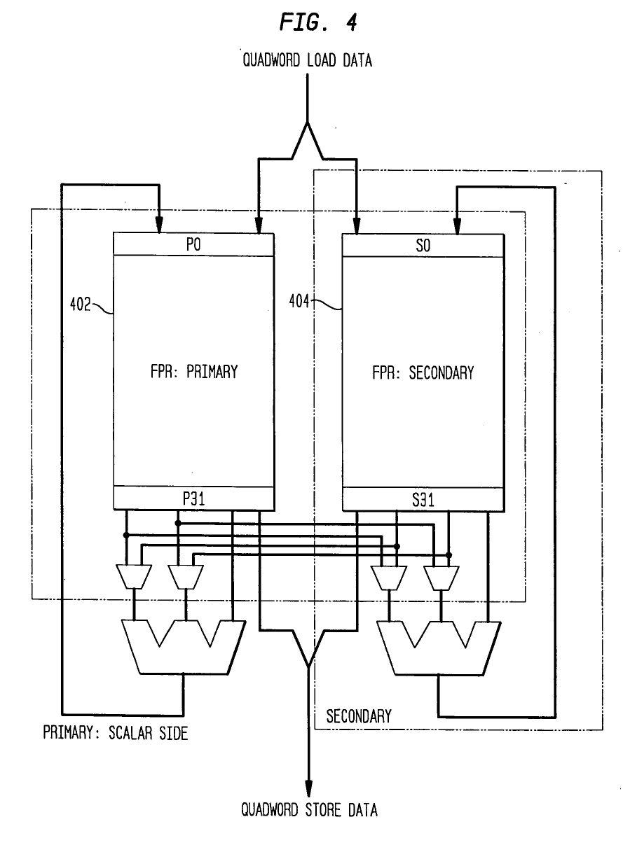

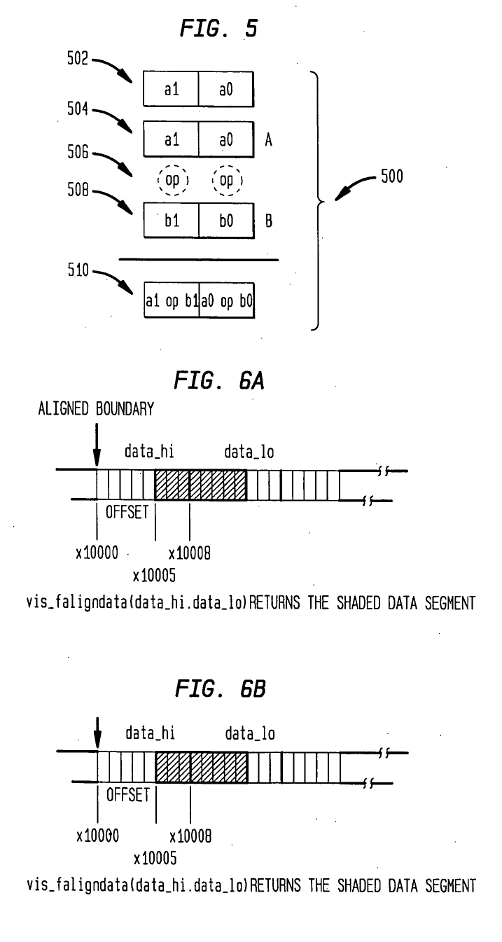

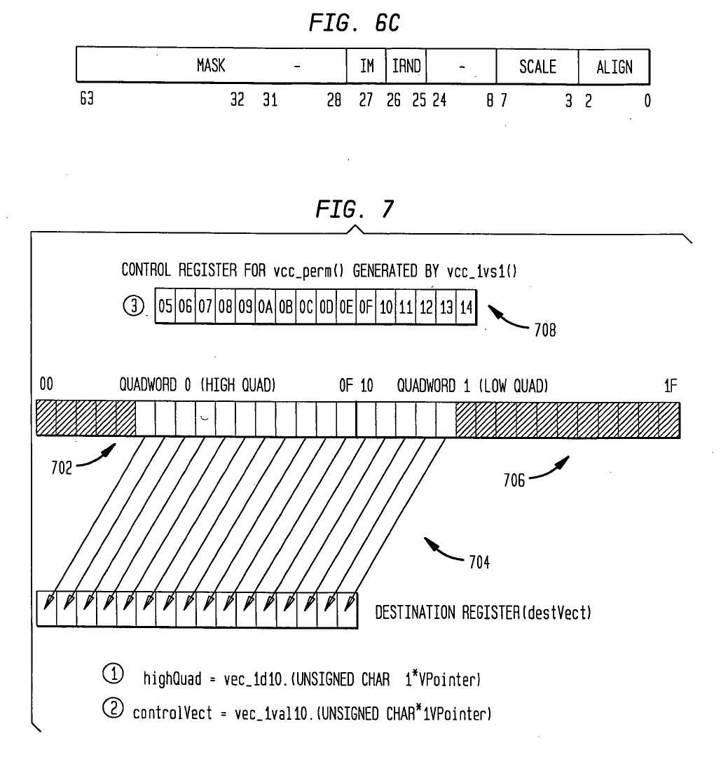

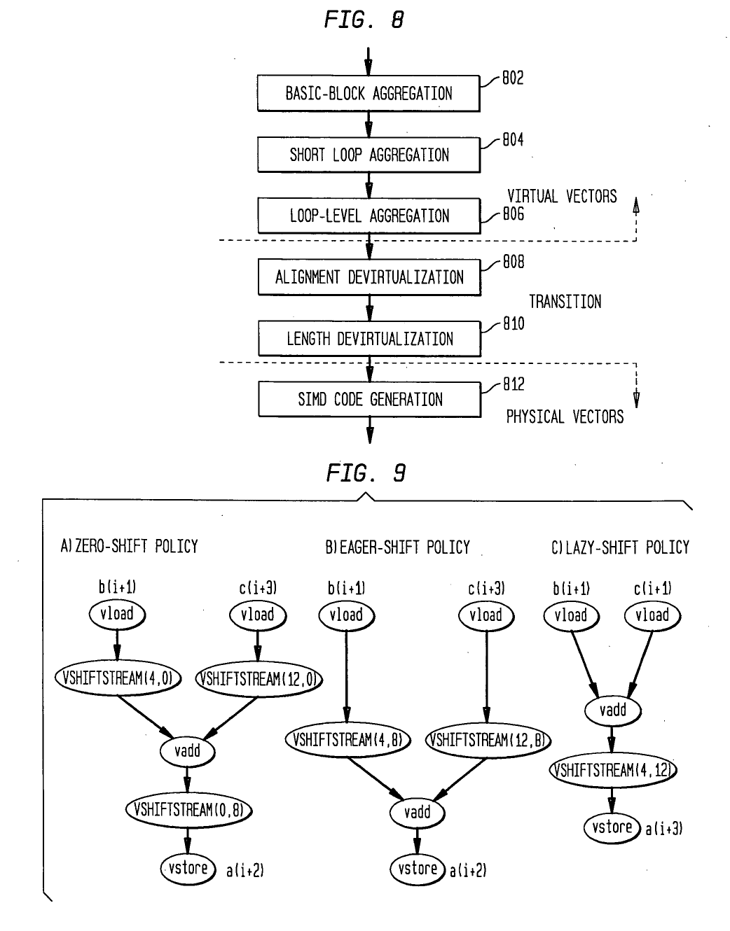

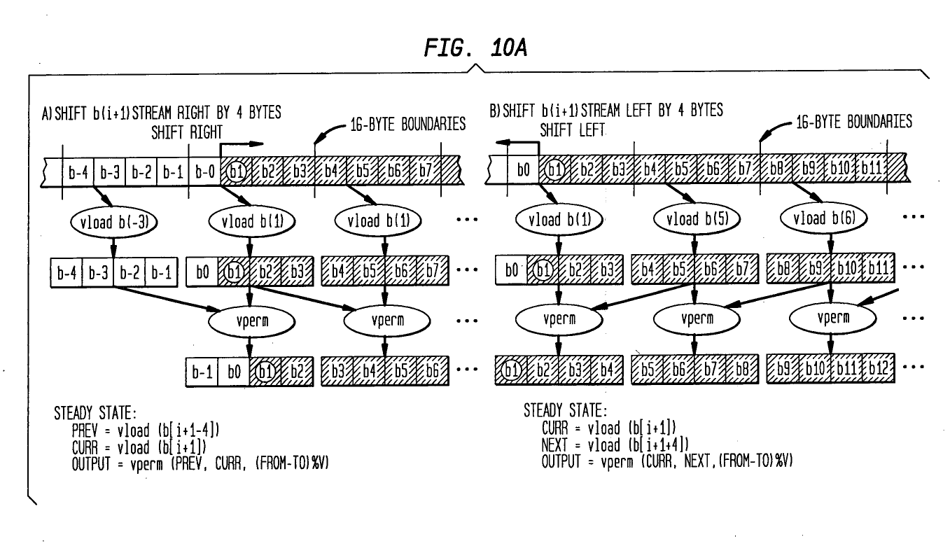

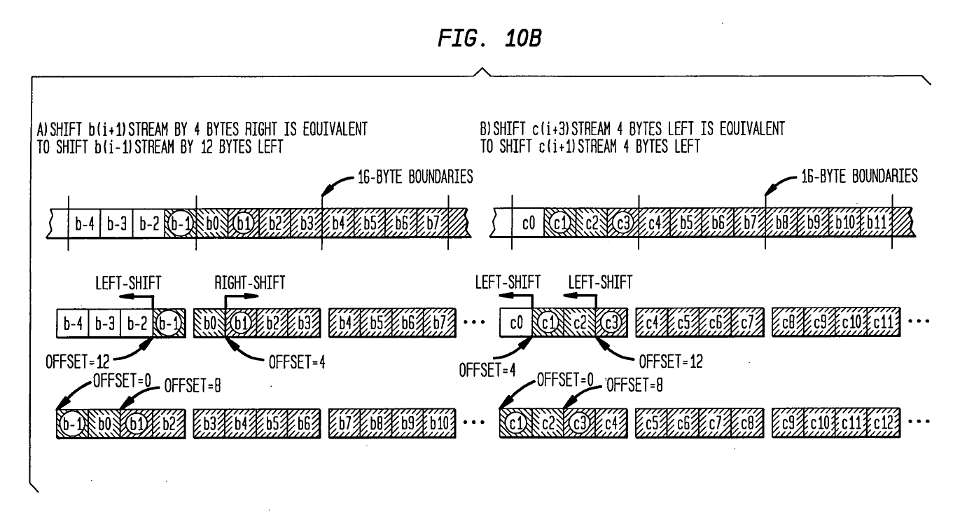

Referring now to FIG. 4, we show an environment wherein the above embodiment can be implemented in the PowerPC 440 FP2 Core. FIG. 4 shows the data path of a processor such as the FP2 unit of a Bluegene/L system. The PowerPC 440 FP2 Core design, goes beyond the advantages of adding another pipeline and of the SIMD approach. FIG. 4 shows the design (not drawn to scale) of the FP2 core. Instead of employing a traditional vector register file, this architecture uses two copies of the architecturally-defined PowerPC floating-point register file which together yield a two-element 128 bit SIMD vector, as shown in FIG. 5. The data path includes a primary register file 402; a secondary register file 404; and a processing pipeline for preparing data for processing and for processing the data by the primary and secondary register files.

Both register files are independently addressable; in addition, they can be jointly accessed in a SIMD-like fashion as a tuple (i.e., a value tuple consisting of the values stored in the primary and secondary register files, 402 and 404, at the named register location) by instructions using the present embodiment. The common register addresses used by both register files 402 and 404 has the added advantage of maintaining the same operand hazard/dependency control logic used by the PowerPC 440 FPU. The primary register file 402 is used in the execution of the pre-existing PowerPC floating-point instructions as well as new instructions using aspects of the invention, while the secondary register file 404 is reserved for use by the new instructions. This allows pre-existing PowerPC instructions—which can be intermingled with the new instructions—to directly operate on primary side results from the new instructions, adding flexibility in algorithm design which is exploited frequently. New move-type instructions allow the transfer of results between the two sides. PowerPC instructions are an example of fixed-width RISC instruction targeting a microprocessor having a primary and secondary set of floating point registers.

Along with the two register files, there are also primary and secondary pairs of datapaths, each consisting of a computational datapath and a load/store datapath which together constitute a single double-wide integrated SIMD datapath. The primary (resp., secondary) datapath pair write their results only to the primary (resp., secondary) register file. Likewise, for each computational datapath, the B operand of the FMA (floating multiply-add) is fed from the corresponding register file. However, the real power comes from the operand crossbar that allows the primary computational datapath to get its A and C operands from either register file. This crossbar mechanism enabled us to create useful operations that accelerate matrix and complex-arithmetic operations. The power of the computational crossbar is enhanced by cross-load and cross-store instructions, which add flexibility by allowing the primary and secondary operands to be swapped as they are moved between the register files and memory.

Each FP2 core occupies approximately 4% of the chip area, and consumes about 2 watts in power. Thus, creating the SIMD-like extension for both processors of the compute node doubles the peak floating point capability, at a modest cost in chip area and power, while doubling both the number of FPU registers and the width of the datapath between the CPU and the cache.

The newly defined instructions include the typical SIMD parallel operations 500 (as shown in FIG. 5) as well as cross, asymmetric, and complex operations. The cross instructions (and their memory-related counterparts, cross-load and cross-store) help efficiently implement the transpose operation and have been highly useful in implementing some of our new algorithms for BLAS (Basic Linear Algebra Subprogram) codes that involve novel data structures and deal with potentially misaligned data. Finally, the parallel instructions with replicated operands allow important scientific codes that use matrix-multiplication to make more efficient use of (always limited) memory bandwidth.

The FP2 core supports parallel load operations, which load two consecutive double words from memory into a register pair in the primary and the secondary unit. Similarly, it supports an instruction for parallel store operations. The processor local bus of PPC440 supports 128 bit transfers, and these parallel load/store operations represent the fastest way to transfer data between the processor and the memory subsystem. Furthermore, the FP2 core supports a parallel load and swap instruction, which loads the first double word into the secondary unit register and the second double word into the primary unit register (and its counterpart for store operation). These instructions help implement the kernel for matrix transpose operation more efficiently.

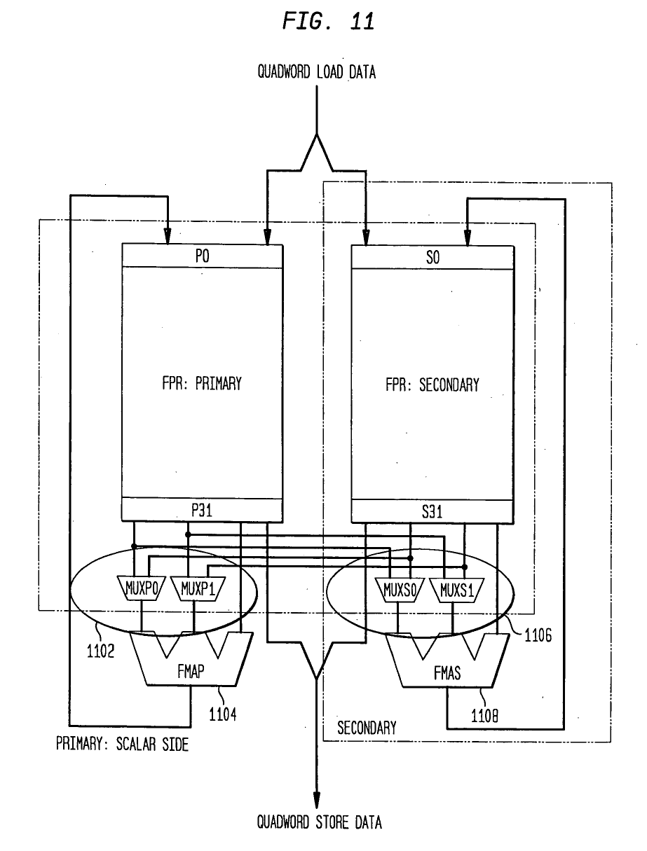

Referring now to FIG. 11, there is shown an embodiment of the invention using the BlueGene/L FP2 data path. The same data path highlights the data steering elements introduced in the BGL FP2 unit design to support cross operations as used by the complex-arithmetic and enhanced matrix operations. The data steering elements 1102 are labeled MUXP0, and MUXP1 for the first and second multiplexers in the primary data path, and the first and second multiplexers (1106) in the secondary data path. The FMA units of the data steering elements primary and secondary data path are denoted FMAP 1104 and FMAS 1108, respectively.

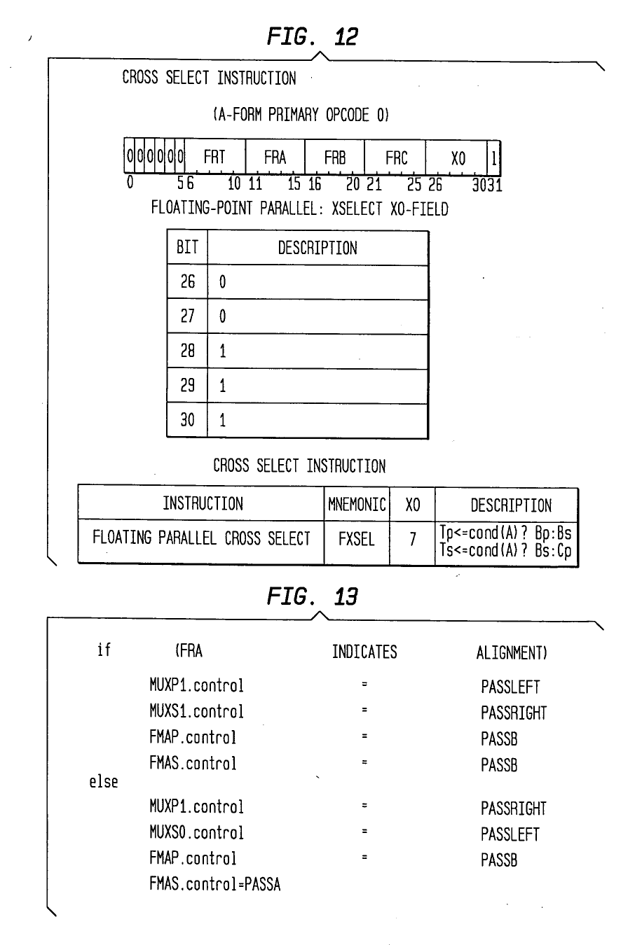

Referring now to FIG. 12, there is shown an exemplary instruction Floating Parallel Cross Select Instruction (“fxsel”) to perform dynamic (runtime-determined) data realignment in accordance with a preferred embodiment of the present invention, and its pertinent ISA (industry standard architecture) aspects. Specifically, there is shown an encoding of the fxsel instruction using a 32 bit RISC instruction word. The instruction word is encoded as an “A-type” instruction. Specifically, the instruction word consists of (1) A 6 bit primary opcode field having the value “000000”, (2) A 5 bit target register specifier FRT, specifying one of 32 registers to receive the result of the operation, (3) Three 5 bit source register specifiers FRA, FRB, FRC providing a first, second, and third input register, (4) A 5 bit secondary or extended opcode field XO, (5) And an unused 1 bit field denoted with the strikeout character “/” which is ignored in the BGL FP2 architecture specification of extended FP2 instructions.

In accordance with the exemplary instruction encoding, the X) field comprising instruction bits 26, 27, 28, 29, 30 has the value of “00111” to denote the fxsel instruction (also specified as decimal XO opcode 7).

In accordance with the functional specification of the fxsel instruction which implements a conditional cross select, the result stored in the result register (the output parameter) is specified as a function of the alignment specification stored in input register FRA which serves as dynamic parameter, i.e., it is a parameter for which the value is supplied at runtime, in accordance with the following logic:

If (FRA indicates correctly aligned)

FRT<=FRB[0]|FRB[1]

else

FRT<=FRB[1]|FRC[0]

In this pseudo notation, the left arrow <= indicates assignment to a short parallel SIMD vector register, and a vector's element's can be accessed with the subscript operator [ ]. A subscript [0] identifies the leftmost element of a vector, a subscript of [1] the second from left field, and so forth. The concatenation operator | is used to concatenate scalar elements to form a vector.

FIG. 12 provides an alternate way to express the operation of the fxsel instruction as well: In accordance with the equations
Tp<=cond(A)?Bp:Bs
Ts<=cond(A)?Bs:Cp

The result of the conditional cross select is controlled by the condition stored in register A, denoted by “cond(A)”. The conditional operator ?: is used in accordance with the C language semantics, wherein x?y:z yields the result of expression y if expression x evaluates to TRUE, and the result of express z otherwise. The subscripts p and s are used to denote the primary and secondary element of a 2 element BGL FP2 SIMD vector.

In accordance with this view of the operation, the primary component of the result vector T receives the primary component of input vector register B if the condition stored in input vector register A indicates that the vector is correctly aligned, and the secondary element of input vector register B otherwise. The secondary component of the result vector T receives the secondary component of input vector register B if the condition stored in input register A indicates that the vector is correctly aligned, and the primary element of input vector register C otherwise.

Referring again to FIG. 11, based on the pre-existing dataflow of FIG. 11, no data flow additions are necessary in the BGL FP2 unit to implement this instruction. The condition is extracted from a first data register FRA, and used to steer the advanced routing network of the paired floating point unit.

This instruction can be used by code generation strategies to generate runtime data-driven alignment, by setting up the condition A in the loop preheader. A variety of encodings are possible to store the alignment information in register A. In a preferred embodiment, a single bit in bit position 28 indicates whether a vector data stream needs to be realigned. This encoding can be set up by transferring the address of the first vector stream element stored in a general purpose registers (GPR) to a floating point register FRA.

According to an optimized embodiment, there is provided a way to generate the condition expression, and transfer to a floating point register. According to another embodiment, the condition is stored in a condition or integer (general purpose) register.

In one embodiment, alignment information is stored in a floating point register (FPR). In another optimized embodiment, alignment information is stored in a general purpose register (GPR). In yet another embodiment, it is used in some other storage medium, such as, but not limited to, a condition register file, a predicate register file, a SIMD register file, an SPR special purpose register, a memory location, and the like.

Moving between GPR and FPR is expensive. In an optimized implementation, alignment information is computed only once in the loop preheader, and the transfer cost is only occurred once per loop. In traditional PowerPC implementations, this required a store GPR to memory and a following load to FPR. In some HW implementations this can be expensive. In one optimized embodiment, a special instruction (such as a special load instruction) derives the address and bypasses it from the LSU to the FPR.

In one aspect of this invention, a FPR (floating point register, or other such storage element as disclosed above) is used to maintain information about the alignment of several SIMD vector streams. An additional instruction word field identifies for each conditional cross select, which bit or plurality of bits in the FPR containing alignment information for multiple streams indicates alignment or misalignment for the current stream. That information is then used to steer a plurality of selector circuits (e.g., a sequence of multiplexers) to extract information for the current stream. The additional opcode field might be encoded as a stream ID field in the instruction word, as an offset into the storage element, and so forth.

In one embodiment, the register storing alignment information for the stream is explicitly encoded as a register specifier. In another embodiment, the register storing the alignment information is implicit, i.e., it is not explicitly specified and instead found in a predefined, instruction-specific register.

Referring now to FIG. 13, there is shown the control logic for implementation of an exemplary “fxsel” dynamic data alignment instruction of FIG. 12 in a data path of FIG. 11.

In accordance with this control logic specification, the FP2 dual floating point unit implements the fxsel instruction without additions to the data path presently available by exploiting data steering control provided for complex arithmetic instructions. Specifically, when the input register FRA indicates correct alignment, the multiplexer MUXP1 is configured to pass its left input by setting its control accordingly, and the multiplexer MUXS1 is set to pass its right input by setting its control. The controls for FMAP 1104 and FMAS 1108 are set for both units pass the second of three inputs (port B) to the output.

When the input register FRA indicates the need to perform dynamic realignment, the multiplexer MUXP1 is configured to pass its right input by setting its control accordingly, and the multiplexer MUXS0 is set to pass its left input by setting its control. The controls for FMAP 1104 and FMAS 1108 are set for both units to pass the second (port B) and first (port A) of three inputs, respectively, to the output.

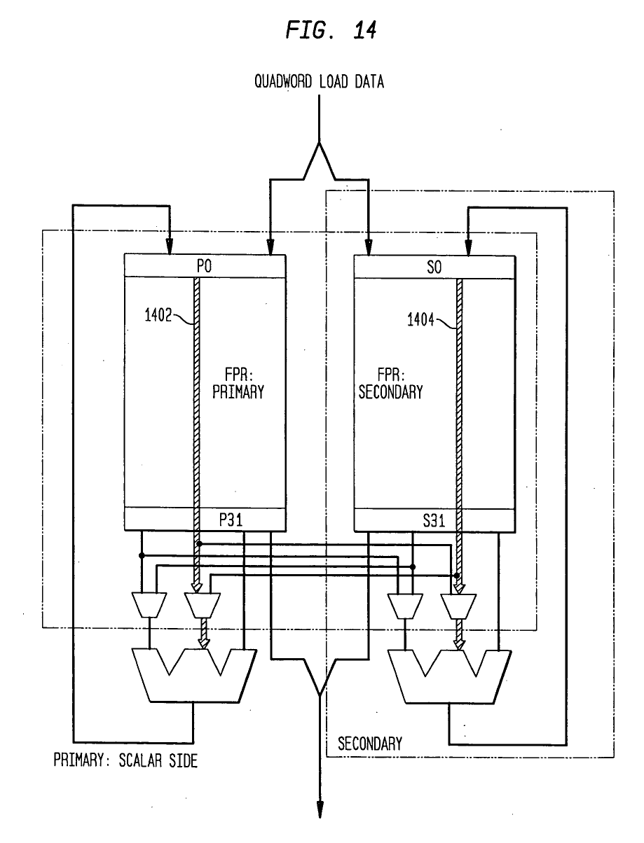

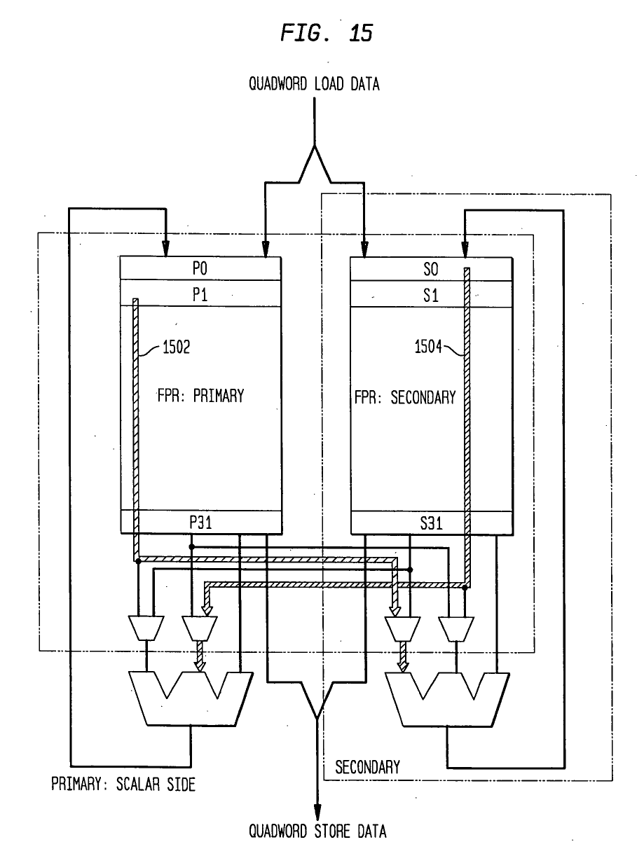

Referring now to FIGS. 14 and 15, there is shown the flow of data in accordance with the exemplary implementation of dynamic data realignment in an integrated data preparation and processing path in accordance with the present invention. In FIG. a datapath 1402 is provided for the primary register and a datapath 1404 is provided for the secondary floating point register. Specifically, FIG. 14 shows the steering of data 1402, 1404 when the register FRA indicates that the data is already aligned, and FIG. 15 shows the occurrence of dynamic data realignment into datapaths 1502 and 1504.

Having thus disclosed the numerous advantageous aspects of supporting a low complexity alignment primitive, the primitive being architected to exploit a nontraditional SIMD architecture offering increased data routing flexibility in the data path, we now turn to the advantageous steps and processes being performed in a compiler to exploit this feature in one preferred embodiment.

While the data alignment disclosed herein is optimized towards aligning elements within a vector, wherein the vector elements are properly naturally aligned, but not aligned within vector boundaries. This is advantageous, because compilers and runtime environments can ensure proper natural alignment of scalar elements. While this is the preferred embodiment, some application binary interfaces (ABIs), and specifically the POWERPC AIX ABI, support non-naturally aligned scalar element types. To support such ABIs, compilers can use a variety of techniques to discover non-naturally aligned element pointers, e.g., by using code versioning, or by exploiting a BGL FP2 paired load unaligned exception. Alternatively, hardware can be added to support more flexible data rearrangement—at increased hardware complexity cost.

According to the present invention, data steering is implemented as an integral function of the data path. This is achieved by computing control signals for multiplexers M1-M4 to either allow the passing of straight non-crossed double float elements, or the selection of a secondary element from a first register, and a primary element from a second register, to be stored in the first and second elements of the target vector, respectively.

When data is read from an aligned stream, this operation—under control of an alignment indicator—performs a move operation, with no further realignment of data items:

When data is read from an unaligned stream, this operation, this operation under control of an alignment indicator—performs an alignment operation by selecting a first element 2i+1 and a second element 2i+2, and merges them into a vector containing these elements. (Note that such a quadword load cannot be loaded directly due to alignment constraints.)

This approach results in high performance, as data alignment can be performed without static knowledge of alignment information, by detecting alignment on the fly. Furthermore, this operation results in a cost of a single alignment operation per two elements of a stream, and no additional memory traffic, as one vector can be carried across loop iterations as follows in this simple example demonstrating the alignment of a potentially unaligned vector pointed to by rl2, to a guaranteed aligned vector pointed to by rl3:

| (fr8 is loaded with alignment information here) | |
|---|---|
| xor | r18,r18,r18 ; r18 = 0 |
| add | r19 = r12, r18 |
| st | temp, r19 |
| lf | fr8, temp |
| andi | r12, r12, FFFFFFF0 ; eliminate unaligned address bit |
| loadquad | fr4, r12(r18) |
| addi | r18 = r18 + 16 |

loop:

| | |
|---|---|
| loadquad | fr5, r12(r18) |
| fxsel | fr6, fr4, fr5, fr8 ; result aligned in fr6 |
| stquad | fr6, r13(r18) |
| addi | r18 = r18 + 16 |
| bdnz | loop ; loop on counter |

The implementation is desirable because no additional datapath elements are necessary. This is a significant advantage over previous designs requiring a permute or shuffle unit. No additional load is placed on the output of registers, and no pipeline registers are necessary. The single addition is an extended instruction decoder, and control logic generating controls for multiplexers M1-M4, and setting up function units to pass data unmodified. Thus, a compiler performs the following tasks:
identify SIMDizable code;
generate intermediate shift stream representation;
generate code to compute dynamic runtime alignment;
transfer to required presentation in register FRA;
translate shift stream code to paired FP code, utilizing fxsel to dynamically align data streams

FIG. 8 outlines the six main components of a simdization framework. The first three phases extract SIMD parallelism at different program scopes into generic operations on virtual vectors. Virtual vectors serve as a basis to abstract the alignment and finite length constraints of the SIMD architecture. This corresponds to Task 1 above. The next two phases progressively de-virtualize virtual vectors to match the precise architecture constraints. These two steps correspond to Task 2. The final phase lowers the generic vector operations to platform specific instructions. This implements Tasks 3, 4, and 5 above.

Phase I: Basic-block level aggregation 802. This phase extracts SIMD parallelism within a basic block by packing isomorphic computation on adjacent memory accesses to vector operations. Vectors produced by this phase have arbitrary length and may not be aligned.

Phase II: Short loop aggregation 804. This phase eliminates simdizable inner loops with short, compile-time trip counts by aggregating static computation on stride-one accesses across the entire loop into operations to longer vectors. Given a short loop with compile-time trip count u, any data of type t in the loop becomes vector V(u,t) after the aggregation. Vectors produced by this phase have arbitrary length and may not be aligned.

Phase III: Loop-level aggregation 806. This phase extracts SIMD parallelism across loop iterations. Computations on stride-one accesses across iterations are aggregated into vector operations by blocking the loop by a factor of B. Any data of type t in the loop becomes vector V(B,t) after the aggregation. The blocking factor B is determined such that each vector V(B,t) is always a multiple of PVL bytes, i.e. B* len(t) mod P_{VL}=0. The smallest such blocking factor is
B=P_{VL}/GCD(P_{VL},len(t₁), . . . ,len(tₖ)),
where GCD computes the greatest common divisor among all the inputs. Vectors produced by this phase have a vector length that is multiple of PVL bytes but may not be aligned.

Phase IV: Loop-level alignment devirtualization 808. This phase transforms loads and stores from possibly unaligned vectors to aligned vectors using the stream-based alignment handling algorithm. This algorithm is able to handle loops with arbitrary misalignments. In our algorithm, stride-one memory accesses across iterations are viewed as streams. Two streams are considered as relatively misaligned if their first elements have different alignments, called stream offset. When misaligned, it performs a stream shift on one of the two streams, by shifting the entire stream across registers to match the offset of the other stream. Vectors produced by this phase are always aligned and have a vector length that is multiple of PVL bytes.

Phase V: Length devirtualization 810. In this phase, vectors are first flattened to vectors of primitive types. It then maps operations on virtual vectors to operations on multiple physical vectors or revert them back to scalar operations. The decision is based on the length of the vector, whether the vector is aligned, and other heuristics that determine whether to perform the computation in vectors or scalars. Vectors produced by this phase are physical vectors.

Phase VI: SIMD code generation 812. This phase maps generic operations on physical vectors to one or more SIMD instructions or intrinsics, or to library calls according to the target platform.

A distinct characteristic of this framework is that simdization is broken down to a sequence of transformations, each of which gradually transforms scalar computation to computation on physical vectors. This process is clearly illustrated by the evolution of data properties through each phase:

First, the three aggregation phases convert scalar computations to generic operations to packed, unaligned vectors of arbitrary length. Then, alignment devirtualization transforms unaligned vectors to aligned ones, making virtual vectors one step closer to physical vectors. Next, length devirtualization maps aligned virtual vectors to physical vectors. Finally, generic vector operations are lowered to platform specific SIMD instructions.

We now focus on the phases that involve the fxsel instruction described herein. Consider first Phase IV in more detail. It attempts to minimize the number of data reorganization by lazily inserting data reorganization (shiftstream) until absolutely needed. In doing so, it introduces shiftstream only when two streams are relatively misaligned with each other. In accordance with the present invention, the fxsel instruction has been advantageously architected such that stream shift operations will be easily mapped to fxsel operations in Phase VI. Thus this phase proceeds smoothly, without having to introduce loop replication due to misaligned data streams.

Several optimizations are available. They mostly have to do with that alignment is known at compile time for either all of the memory streams or part of the memory stream. In essence, because of the richness of the data path in the memory and floating point units, data can often be reorganized for free, when known at compile time. For example, stream-shifts that can be located next to loads can be had for free because of the load “straight” and “cross” operation. Similarly, stream-shifts located after multiply, multiply and add can also be had for free. So we propose to embed this knowledge in the algorithm that place the stream-shift to obtain legal computation with minimum of costly data reorganization.

Let us now focus on Phase VI in more detail. One of the first tasks is to replace the stream-shifts by the actual operation on the target machine. For the stream-shifts that can be combined with their operation X directly feeding into them, where operation X is a load, multiply, multiply and add, we can generate the “straight” or “cross” version of op X when the alignment is know at compile time for that particular stream-shift. Otherwise, an fxsel instruction is generated for the remaining stream-shift operations. For these that are runtime, extra computation must be set prior to the loop to set the 1st input operand of each fxsel that determine at runtime whether that operation will move the data straight or cross. Since the relative alignment is considered here, the final condition corresponds to an XOR of whether both alignment are aligned or not (i.e., if both are aligned (0 mod 16) or both are misaligned (8 mod 16), no crossing of path is needed; however, if one is aligned and the other is not, then crossing is needed.

Extra care is also needed for the first and last iteration of the loop, as one cannot produce more results than the number in the initial, non simdized loop. If the first iteration would need to store only one double, then its produced with regular, nonsimdized operations. If there are two, then we simply enter the simdized loop right away. Same with the epilogue: if in the last iteration, there is one double to store, its done with regular non simdized operations; otherwise, we just stay in the simdized loop one more time.

Therefore, while there has been described what is presently considered to be the preferred embodiment, it will understood by those skilled in the art that other modifications can be made within the spirit of the invention.

We claim:

1. A method for processing instructions and data in a processor, the method comprising steps of:
preparing an input stream of data for processing in a data path in response to a first set of instructions specifying a dynamic parameter; and
processing the input stream of data in the same data path in response to a second set of instructions;
wherein a common portion of a dataflow is used for preparing the input stream of data for processing in response to the first set of instructions under the control of the dynamic parameter specified by an instruction of the first set of instructions, and for operand data routing based on the instruction specification of the second set of instructions during the processing of the input stream in response to the second set of instructions.

2. The method of claim 1, wherein the step of preparing the input stream of data comprises aligning the data by performing a conditional select operation using multiplexing logic embedded into a computational datapath, the conditional select logic being under the control of alignment information provided to the alignment instruction as a dynamic parameter.

3. The method of claim 2, wherein alignment is achieved in a first mode by selecting a first and a second element of a first value tuple, and in a second mode by selecting a second element of the first value tuple and a first element of a second value tuple, the tuples being stored in specified register input parameters, and storing the selected elements as a single value tuple in a specified register output parameter, the mode being selected by alignment information provided as a dynamic parameter.

4. The method of claim 3 wherein the alignment is performed in response to a data driven alignment operation wherein alignment information is specified as a dynamic parameter.

5. The method of claim 3 wherein the dynamic alignment parameter is stored in one of a vector register, floating point register, integer register, condition register, special purpose register, alignment register, or other register, the register encoded in either one of implicitly and explicitly in the instruction.

6. The method of claim 4 wherein the conditional select logic used to implement the dynamic data alignment under the control of the dynamic parameter is used to implement instruction-dependent data routing to implement at least one computational instruction.

7. The method of claim 5 wherein the at least one computational instruction is a double precision IEEE floating point complex arithmetic instruction.

8. The method of claim 5 wherein the instruction is specified as a Fixed-width RISC instruction targeting a microprocessor having a primary and secondary set of floating point registers, the output specifier being one of 32 paired floating point registers, a first and second input specifiers being one of 32 paired floating point registers, and the dynamic alignment being specified in a third input specifier as one of 32 paired floating point registers.

9. The method of claim 7 wherein the fixed-width RISC instruction has been generated using a compiler method equipped to extract SIMD parallelism from scalar code, the compiler method comprising steps of:
aligning devirtualization, by inserting the fixed-width RISC instruction, loop prolog code generation, including the steps of generating instructions to determine alignment at runtime and loading the information to at least one paired double precision floating register to serve as dynamic alignment specification for the generated PowerPC dynamic alignment instruction.

10. A processor comprising:
a primary register file;
a secondary register file; and
a processing pipeline for: preparing an input stream of data for processing in a data path in response to a first set of instructions specifying a dynamic parameter; and processing the input stream of data in the same data path in response to a second set of instructions,
wherein a common portion of the dataflow is used for preparing the input stream of data for processing in response to the first set of instructions under the control of the dynamic parameter specified by an instruction of the first set of instructions, and for operand data routing based on the instruction specification of the second set of instructions during the processing of the input stream in response to the second set of instructions.

11. The processor of claim 10 wherein the data preparation step comprises aligning the data using one of operand routing logic and an operand crossbar embedded into a computational datapath, the conditional select logic being under the control of alignment information provided to the alignment instruction as a dynamic parameter.

12. The processor of claim 10 wherein alignment is achieved in a first mode by selecting a first and a second element of a first value tuple, and in a second mode by selecting a second element of the first value tuple and a first element of a second value tuple, the tuples being stored in specified register input parameters, and storing the selected elements as a single value tuple in a specified register output parameter, the mode being selected by alignment information provided as a dynamic parameter.

13. The processor of claim 12 wherein the alignment is performed in response to a data driven alignment operation wherein alignment information is specified as a dynamic parameter, stored in one of a vector register, floating point register, integer register, condition register, special purpose register, alignment register, or other register, the register encoded either one of implicitly and explicitly in the instruction.

14. The processor of claim 13 further comprising an additional instruction word field for identifying each conditional cross select, wherein one or more bits in the dynamic alignment parameter comprise alignment information for multiple streams indicating alignment or misalignment for a received information stream.

15. The processor of claim 14 wherein the received information is then used to steer a plurality of selector circuits to extract information for the current stream.

16. The processor of claim 13 wherein the conditional select logic used to implement the dynamic data alignment under the control of the dynamic parameter is used to implement instruction-dependent data routing to implement at least one computational instruction.

17. The processor of claim 16 wherein the instruction is specified as a fixed-width RISC instruction targeting a microprocessor having a primary and secondary set of floating point registers, the output specifier being one of 32 paired floating point registers, a first and second input specifiers being one of 32 paired floating point registers, and the dynamic alignment being specified in a third input specifier as one of 32 paired floating point registers.

18. The processor of claim 17 wherein the fixed-width RISC instruction has been generated using a compiler method equipped to extract SIMD parallelism from scalar code, the compiler method comprising the steps of:
alignment devirtualization, by inserting the PowerPC dynamic alignment instruction;
loop prolog code generation, including the steps of generating instructions to determine alignment at runtime and loading the information to at least one paired double precision floating register to serve as dynamic alignment specification for the generated PowerPC dynamic alignment instruction.

19. A computer-readable medium comprising instructions for processing instructions and data in a processor, the medium comprising instructions for:
preparing an input stream of data for processing in a data path; and
processing the input stream of data in the same data path.

20. The medium of claim 19, wherein instructions target a data path including a common dataflow used for operand data routing based on the instruction specification of the said first set of instructions during the processing of the input stream in response to the said first set of instructions, and preparing the input stream of data for processing in response to the said second set of instructions under the control of the dynamic parameter specified by an instruction of said second set of instructions.

21. The medium of claim 19, wherein the step of preparing the input stream of data comprises aligning the data by performing a conditional select operation using multiplexing logic embedded into a computational datapath, the conditional select logic being under the control of alignment information provided to the alignment instruction as a dynamic parameter.

22. The medium of claim 19, wherein alignment is achieved in a first mode by selecting a first and a second element of a first value tuple, and in a second mode by selecting a second element of a first value tuple and a first element of a second value tuple, the tuples being stored in specified register input parameters, and storing the selected elements as a single value tuple in a specified register output parameter, the mode being selected by alignment information provided as a dynamic parameter.

23. The medium of claim 22 wherein alignment is achieved using a fixed-width RISC instruction targeting a microprocessor having a primary and secondary set of floating point registers, the output specifier being one of 32 paired floating point registers, a first and second input specifiers being one of 32 paired floating point registers, and the dynamic alignment being specified in a third input specifier as one of 32 paired floating point registers.

24. The medium of claim 20 wherein the instructions have been generated using a compiler method equipped to extract SIMD parallelism from scalar code, the compiler method comprising the steps of:
alignment devirtualization, by inserting the fixed-width RISC instruction, loop prolog code generation, including the steps of:
instruction generation to determine alignment at runtime; and
instruction generation to load to at least one paired double precision floating register the information that serves as dynamic alignment specification for the generated PowerPC dynamic alignment instruction.

25. A method comprising steps of:
extracting SIMD parallelism within a block of data received by packing isomorphic computation on adjacent memory accesses to vector operations;
aggregating static computation on stride-one accesses across the entire loop into operations to longer vectors
extracting SIMD parallelism across loop iterations;
transforming loads and storing from possibly unaligned vectors to aligned vectors using a stream-based alignment handling algorithm;
inserting the conditional cross-select alignment instructions to generate properly aligned data wherein alignment is achieved in a first mode by selecting a first and a second element of a first value tuple, and in a second mode by selecting a second element of a first value tuple and a first element of a second value tuple, the tuples being stored in specified register input parameters, and storing the selected elements as a single value tuple in a specified register output parameter, the mode being selected by alignment information provided as a dynamic parameter; said conditional cross-select alignment instruction being capable of being executed using operand routing logic in a computational datapath.
flattening vectors to primitive types; and
mapping generic operations to physical vectors to one or more SIMD instructions.

26. The method of claim 25 wherein addresses are used to directly as dynamic alignment parameter.

27. The method of claim 25 wherein the dynamic alignment parameter is computed from at least two addresses and used directly as dynamic alignment parameter.

28. The method of claim 27, wherein the alignment parameter is computed using on of the subtraction and XOR operation on said two addresses.
